(19) United States
(12) Patent Application Publication
(10) Pub. No.: US 2012/0007851 A1
(43) Pub. Date: Jan. 12, 2012

(54) METHOD FOR DISPLAY OF IMAGES UTILIZING CURVED PLANAR REFORMATION TECHNIQUES

(76) Inventor: Kazuhiko Matsumoto, Minato-ku (JP)

(21) Appl. No.: 12/834,631

(22) Filed: Jul. 12, 2010

(51) Int. Cl. G06T 15/00

(52) U.S. Cl. 345/419

(57) ABSTRACT

Examples of methods, systems, and computer readable media for aligned display of rendered images are described which may align a direction of display of two or more images rendered using different techniques. The different techniques may include volume rendering and curved planar reformation techniques. The aligned display may facilitate understanding of features in the images.

### TECHNICAL FIELD

The invention relates generally to image visualization techniques, and more particularly to the alignment of images rendered using disparate image visualization techniques.

### BACKGROUND

A variety of medical devices may be used to generate volume data of human anatomy, including computed tomography (CT) and magnetic resonance imaging (MRI) scanners. Volume data generally refers to digital data generated from a three-dimensional scan of an object. Once the volume data has been generated by a medical device such as a MRI or a CT scanner, any of a variety of techniques may be utilized to visualize all or portions of the acquired volume data.

Some of such techniques may be referred to as three-dimensional rendering techniques in that the resultant image appears three-dimensional. However, unless a three-dimensional viewing technique is used, the image generated by three-dimensional rendering techniques may actually be two-dimensional images which appear to display a three-dimensional object. Examples of three-dimensional rendering techniques include volume rendering techniques, maximum intensity projection techniques, and minimum intensity projection techniques.

Generally, volume rendering techniques proceed with reference to a viewpoint from which the volume data will be rendered. An opacity and/or color value for each pixel of the displayed image may be calculated based on volume data viewed from the viewpoint.

Other techniques may generate a two-dimensional representation of a portion of the volume data. For example, a two-dimensional slice of the volume data may be visualized using any technique. Examples of techniques for the generation of a two-dimensional representation of volume data include multiplanar reformation and curved planar reformation techniques. Curved planar reformation techniques may also be referred to as curved planar reconstruction techniques.

FIG. 1 is a schematic illustration of a curved surface for use in generating an image using a curved planar reformation technique. A curve 105 may be specified for use in generating an image using a curved planar reformation technique. The curve 105 may be specified by a user or a computer software process. The curve 105 may correspond to an anatomical feature of interest such as a vessel, intestine, or other anatomical feature. The curve 105 may be made up of multiple points of volume data. A projection vector 110 may also be defined for use in generating an image using a curved planar reformation technique. The projection vector 110 may specify a three-dimensional direction, and may be specified by a user or a computer software process. Lines 115a-s shown in FIG. 1 are straight lines from each of a plurality of points on the curve 105 in the direction of the projection vector 110. The lines 115a-s may then define a curved surface 120. Curved planar reformation techniques may generate a two-dimensional image of the volume data located on the curved surface 120. The resultant image appears flat, corresponding to a projection of the curved surface 120 onto a viewing plane, and accordingly some distortion of the anatomical features represented by the volume data may occur. However, the curved planar reformation technique may be advantageous in viewing anatomical features proximal to the curve 105. That is, the image generated using a curved planar reformation technique may generally highlight the location of the curve 105. However, some or all of the features in the image may be distorted during the image generation process.

### BRIEF DESCRIPTION OF THE DRAWINGS

FIG. 1 is a schematic illustration of a curved surface for use in generating an image using a curved planar reformation technique.

FIG. 2 is a schematic illustration of a medical system in accordance with an embodiment of the invention.

FIG. 3 is a schematic flowchart for a method to render and align images utilizing the system of FIG. 1 according to an embodiment of a method of the present invention.

FIG. 4 is a schematic illustration of a first image generated in accordance with a curved planar reformation technique, such as may be generated by examples of the system of FIG. 2 or method of FIG. 3.

FIG. 5 is a schematic illustration of a second image generated in accordance with a technique distinct from the planar reformation technique, such as may be generated by examples of the system of FIG. 2 or method of FIG. 3.

FIG. 6 is a schematic illustration of two non-aligned images displayed on a display device, which may be an output device of the system of FIG. 2 in some examples.

FIG. 7 is a schematic illustration of two aligned images displayed on a display device, which may be an output device of the system of FIG. 2 in some examples.

FIG. 8 is a schematic flowchart for a method to render and align images utilizing the system of FIG. 1 according to another embodiment of a method of the present invention.

FIG. 9 is a schematic illustration of a first image generated in accordance with a volume rendering technique, which may be generated by examples of the system of FIG. 2 or method of FIG. 3.

FIG. 10 is a schematic illustration of a second image generated in accordance with a curved planar reformation technique, which may be generated by examples of the system of FIG. 2 or method of FIG. 3.

FIG. 11 is a schematic illustration of two non-aligned images displayed on a display device, which may be an output device of the system of FIG. 2 in some examples.

FIG. 12 is a schematic illustration of two aligned images displayed on a display device, which may be an output device of the system of FIG. 2 in some examples.

### DETAILED DESCRIPTION

As was generally described above, a variety of techniques may be used to generate an image based on a set of volume data. Sometimes, more than one technique may be used to generate images of a same feature in a set of volume data. When multiple images are generated based on a set of volume data, they may be simultaneously displayed. It may be difficult, however, to understand the correspondence between the images. That is, images generated using different visualization techniques may be difficult to correlate on a viewing screen, which may make it difficult for a physician or other viewer to understand the images. Examples of methods, systems, and computer readable media for aligned display of rendered images are described below which may align a direction of display of two or more images rendered using different techniques. The aligned display may facilitate understanding of features in the images.

Systems and methods according to embodiments of the present invention may generate image data and display images. Embodiments of the present invention may find use with any volume data and images, including but not limited to the medical context.

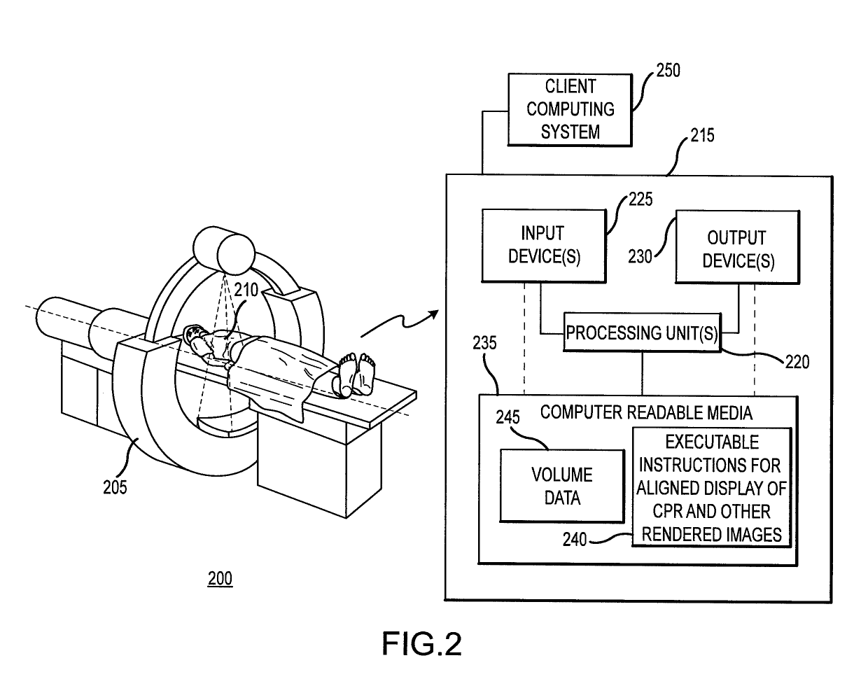

FIG. 2 is a schematic illustration of a medical system 200 in accordance with an embodiment of the invention. A computed tomography (CT) scanner 205 is shown and may collect data from a subject 210. The data may be transmitted to an imaging system 215 for processing. The imaging system 215 may include one or more processing units 220, input devices 225, output devices 230, a memory 235, or combinations thereof. As will be described further below, the memory 235 may store executable instructions for aligned display of rendered images 240. The memory 235 may also store volume data 245 generated by the scanner 205 or other medical device. The executable instructions for aligned display of rendered images 240 may include instructions for rendering all or a portion of the volume data 245 in accordance with multiple techniques including, but not limited to, curved planar reformation and volume rendering techniques. The executable instructions for aligned display of rendered images 240 may further include instructions for aligning an image generated using one technique with an image generated using another technique, examples of which will be described further below. The rendered images may be displayed by one or more display devices which may be one of the output devices 230. Alternatively or in addition, data for display of the rendered images may be stored or communicated to another computing system, such as client computing system 250, for display. The client computing system 250 may communicate with the imaging system 215 through any mechanism, wired or wireless.

Embodiments of the present invention are generally directed to processing of volume data 245. Volume data as used herein generally refers to three-dimensional images obtained from a medical scanner, such as a CT scanner, an MRI scanner, or an ultrasound. Although a CT scanner 205 is shown in FIG. 2, volume data according to embodiments of the present invention may be obtained from a subject using any type of medical device suitable to collect data that may be later imaged. Three-dimensional images, two-dimensional images, or other visualizations may be rendered or otherwise generated using the volume data. The visualizations may represent three-dimensional or two-dimensional information from all or a portion of the scanned region. In other examples, volume data may be received electronically from substantially any source, including electronically generated simulated volume data of medical or other features.

Any of a variety of input devices 225 and output devices 230 may be used, including but not limited to displays, keyboards, mice, network interconnects, wired or wireless interfaces, printers, video terminals, storage devices and any combination thereof.

Although shown encoded on the same memory 235, the volume data 245 and the executable instructions for aligned display of rendered images 240 may be provided on separate memory devices, which may or may not be co-located. Any type of memory may be used.

In some embodiments, users may interface directly with the imaging system 215 using one or more of the input or output devices 225, 230. In other embodiments, a user may interface with the imaging system 215 using the client computing system 250 to transmit data, provide input parameters for image rendering, request image analysis, or receive or view processed data. In such an example, the client computing system 250 need not have sufficient processing power to conduct the image rendering operations described below. The client computing system may send data to a remote imaging system 215 with sufficient processing power to complete the rendering. The client computing system 250 may then receive or access the results of the rendering performed by the imaging system 215. The imaging system 215 in any configuration may receive data from multiple scanners.

It is to be understood that the arrangement of computing components and the location of those components is quite flexible. In one example, the imaging system 215 may be located in a same facility as the medical scanner 205 acquiring data to be sent to the imaging system 215, and a user such as a physician may interact directly with the imaging system 215 to process and display clinical images. In another example, the imaging system 215 may be remote from the medical scanner, and data acquired with the scanner communicated to the imaging system 215 for processing.

Any of a variety of volume data may be manipulated in accordance with embodiments of the present invention, including volume data of human anatomy, including but not limited to, volume data of organs, vessels, or combinations thereof.

Having described a basic configuration of a system according to embodiments of the present invention, techniques for aligned display of rendered images will now be described. Techniques described below may be implemented through cooperation of the executable instructions encoded on the computer readable media 235 and the processing units 220 of FIG. 2 in some examples.

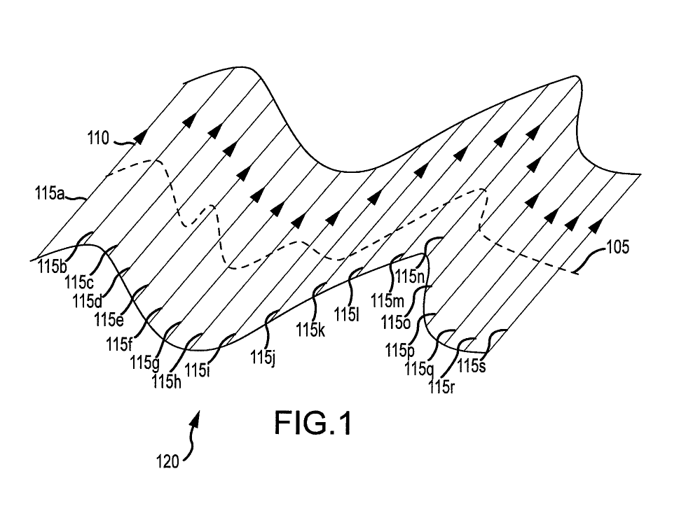

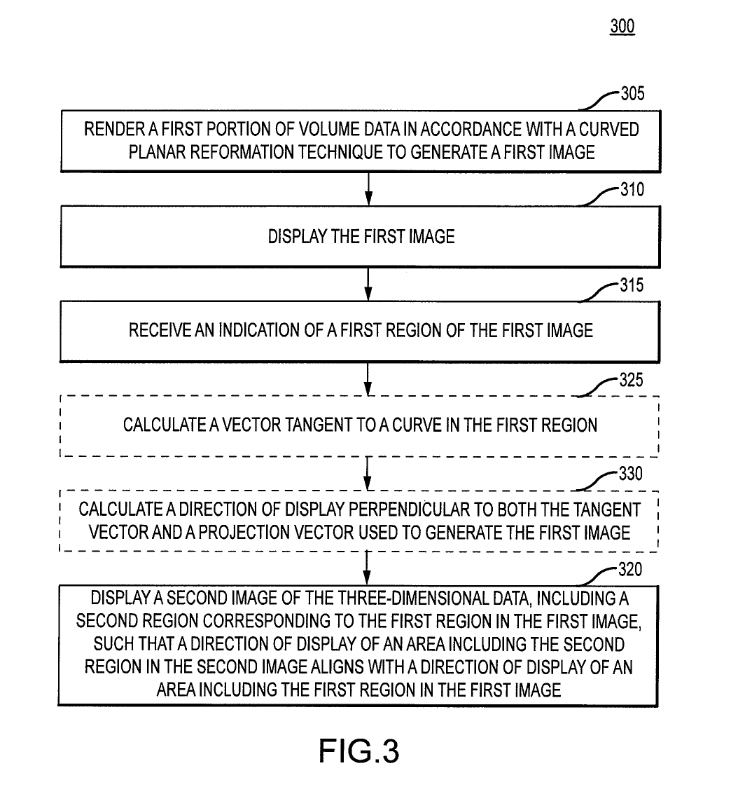

A schematic flowchart for a method 300 to render and align images, which may be performed utilizing a system of the invention, such as system 215, according to an embodiment of a method of the present invention is shown in FIG. 3. At block 305, at least a first portion of volume data may be rendered in accordance with a curved planar reformation technique. One or more of the processing unit(s) 220 of the imaging system 215 of FIG. 2 may perform the rendering in accordance with the executable instructions 240 or other executable instruction. The rendering in block 305 may generate data that may be displayed by a display device, such as an output device 230 of FIG. 2, as a first image. Any curved planar reformation technique may be used. Generally, curved planar reformation techniques render a portion of the volume data by specifying a curve and a projection vector, described above with reference to FIG. 1. The curve and the projection vector may be specified manually by a user or automatically by a computer software process, such as by the client computing system 250 of FIG. 2 or input from an input device 225 of FIG. 2. The curve may correspond to a feature, such as a vessel, spinal feature, or intestine. For example, a user may draw a curve on a displayed image, using an input device 225 or client computing system 250 of FIG. 2, and the curve used to generate a curved planar reformation image in the block 305. The data, displayed image, or both, generated in the block 305 of FIG. 3 is accordingly characterized by the curve and projection vector used during the curved planar reformation technique.

The first image, generated in accordance with a curved planar reformation technique, may be displayed in block 310. Substantially any display device may be used, including for example one of the output devices 230 of FIG. 2. A two-dimensional view of at least a portion of the volume data is accordingly displayed in block 310 which may be characterized by a curve and a projection vector.

An indication of a first region of the first image may be received in block 315. The indication may be provided by a user viewing the image or by another computer software process which analyzed the image. The indication may be provided, for example, using an input device 225 of the imaging system 215 in FIG. 2 or the client computing system 250 of FIG. 2. The first region may be specified, for example, by a user highlighting the region on the image using a mouse or other input device 225 of FIG. 2. The first region may also be referred to as an attention region. The region may be a point, a pixel, or a region enclosing multiple points or pixels. The first region may generally be small relative to deformations of features in the image generated by the curved planar reformation technique. That is, the first region may be characterized by a generally constant direction of display.

In block 320, a second image of the volume data may be displayed. The image may be displayed, for example, on a display which may be an output device 230 of the imaging system 215 of FIG. 2 or using the client computing system 250 of FIG. 2. The second image may be displayed on a same display device as the first image. The second image may be rendered using a technique distinct from the curved planar reformation technique. That is, some other rendering technique may be used to generate the second image, such as volume rendering. The second image contains a second region corresponding to the first region in the first image. That is, the second image includes the portion of the volume data corresponding to the first region of the first image. For example, the first image may be an image of a vessel and surrounding tissue. The second image may be an image of an organ, such as a heart, including the vessel and surrounding tissue. The first region may be a portion of the vessel, shown in both the first and second images. The second image may be rendered such that the direction of display of an area including the second region corresponds to the direction of display of an area including the first region in the first image. In this manner, the first and second images may be aligned to facilitate understanding of the first and second regions.

The first and second images may be aligned in a variety of ways, and the manner in which alignment is achieved may vary based on the technique used to generate the first and second images. In one example, the first image may be generated in accordance with curved planar reformation techniques described above using a curve and a projection vector. In block 325, a vector may be calculated having a direction tangent to the curve within the first region of the first image. The vector may be calculated by one or more processing units, such as the processing units 220 of FIG. 2 in accordance with the executable instructions 240. In block 330, a direction of display may be calculated that is perpendicular to both the tangent vector calculated in block 325 and the projection vector used to generate the first image. The direction of display may be calculated by one or more processing units, such as the processing units 220 of FIG. 2 in accordance with the executable instructions 240. The direction of display calculated in block 325 may be used to generate the second image having a same direction of display in the block 320. For example, the second image may be generated using a volume rendering technique. The volume rendering technique may render an image from a particular viewpoint. In some examples, the viewpoint may be selected to lie on a vector in the direction of display calculated in block 325. Additionally, a rotation of the second image may be selected such that the tangent vector to the curve in the second region is aligned with the tangent vector to the curve in the first region of the first image. The rotation may be selected, for example by one or more processing units, such as the processing units 220 of FIG. 2 in accordance with the executable instructions 240.

In some examples, the second image may be generated responsive to receipt of the indication of the first region. In some examples, the second image may be generated prior to receipt of the indication of the first region, and a viewpoint, rotation, or both, of the second image may be adjusted responsive to receipt of the indication of the first region in block 315. In some examples, the two images may be linked such that as the selected first region changes in the first image, the second image is continuously adjusted to maintain alignment with the first image. Continuous adjustment of the second image may be advantageous in many examples. For example, as described above, the first image may be generated using curved planar reformation techniques. The curved planar reformation image may have a varying direction of display from point to point along a line of interest. In embodiments of the present invention, as different attention regions are selected on the curved planar reformation image, another image, such as a volume rendering image, may be adjusted to align with the curved planar reformation image. This may enhance understanding of one or more features depicted in the images, as a user may view the volume rendering image in alignment with the curved planar reformation image as the attention region changes.

The executable instructions 240 of FIG. 2 may include instructions for performing any or all of the actions described above with reference to FIG. 3.

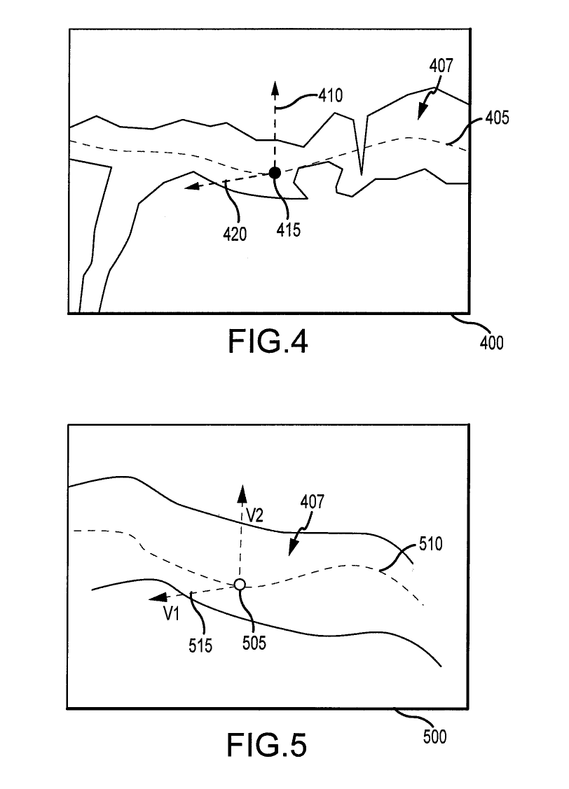

A schematic illustration of a first image 400 generated in accordance with a curved planar reformation technique utilizing for example method 300 and system 215 is shown in FIG. 4. The image 400 illustrates a portion of a vessel 407 of a mammalian heart. The image 400 may be displayed on an output device 230 of the imaging system 215 or by client computing system 250 of FIG. 2, for example. The first image 400 may be generated by one or more of the processing units 220 of FIG. 2 based on at least a portion of the volume data 245. The first image 400 may be characterized by the curve 405 and projection vector 410. The curve 405 generally tracks the vessel 407. A first region 415 may be specified by a user, such as by clicking on the image. The tangent vector 420 may be calculated responsive to the indication of the first region. As described above, the tangent vector 420 may be calculated by one or more processing units 220 in accordance with executable instructions 240 of the imaging system 215 of FIG. 2. The tangent vector 420 has a direction tangent to the curve 405 at the first region 415. As described above, a direction of display may be calculated that is perpendicular to both the vectors 410 and 420. The direction of display may be calculated by one or more processing units 220 in accordance with executable instructions 240 of the imaging system 215 of FIG. 2.

A schematic illustration of a second image 500 generated in accordance with a technique distinct from the planar reformation technique, utilizing for example method 300 and system 215, is shown in FIG. 5. The image 500 illustrates a portion of the vessel 407 of a mammalian heart, the same vessel 407 depicted in the image 400. The image 500 may be displayed on an output device 230 of the imaging system 215 or by client computing system 250 of FIG. 2, for example. The image 500 may be displayed on a same or a different display device as the image 400. The second image 500 may be generated by one or more of the processing units 220 of FIG. 2 based on at least a portion of the volume data 245, some of the same volume data 245 may be used to generate the image 400 as is used to generate the image 500. A second region 505 depicts corresponding volume data as the first region 415 of the first image 400 of FIG. 4. The second image 500 may also include a corresponding curve 510. The second image 500 may be rendered from a viewpoint that lies along the direction of display calculated with respect to the first image 400. The rendering may be performed, for example by one or more of the processing units 220 of the imaging system 215 of FIG. 2 in accordance with the executable instructions 240. Further, the image 500 may be rotated such that a vector 515 tangent to the curve 510 is aligned in a same direction as the vector 420 of FIG. 4. In this manner, the image 500 may be aligned with the image 400, which may facilitate understanding of the features in the images.

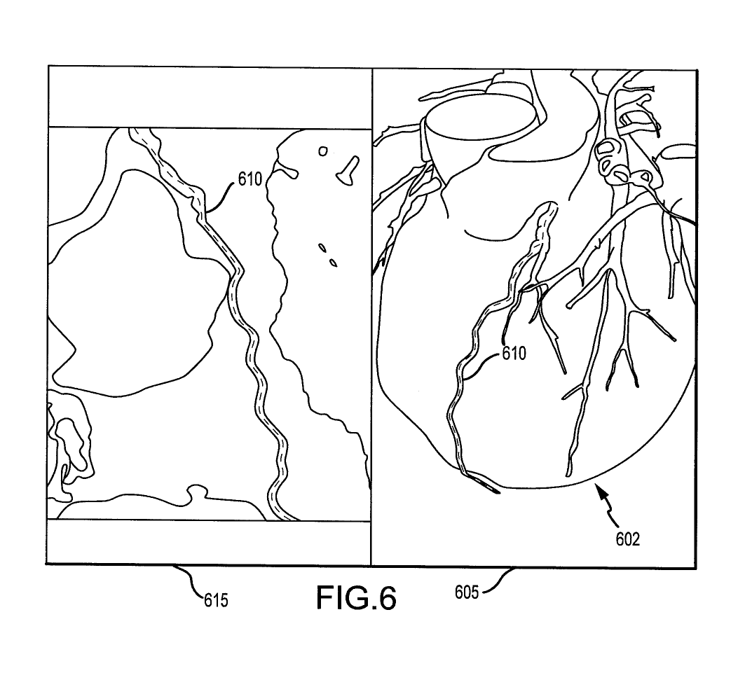

In a further illustration of an example of the invention, a schematic illustration of two non-aligned images displayed on a computer display device, such as display device or monitor 230 of FIG. 2, is shown in FIG. 6. The image 605 was generated in accordance with a volume rendering technique, and may be generated by one or more of the processing units 220 of FIG. 2 using at least a portion of the volume data 245. A heart 602 is shown, and includes a vessel 610. A curve may be defined along the vessel 610 and used to generate another image, the image 615, in accordance with curved planar reformation techniques. The image 615 may also be displayed on an output device 230 of the imaging system 215 of FIG. 2, and may be displayed on a same or difference device as the image 605. The image 615 also illustrates the vessel 610. However, note that the images 605 and 615 are not aligned. The orientation of the vessel 610 in image 605 is different than the orientation of the vessel 610 in image 615.

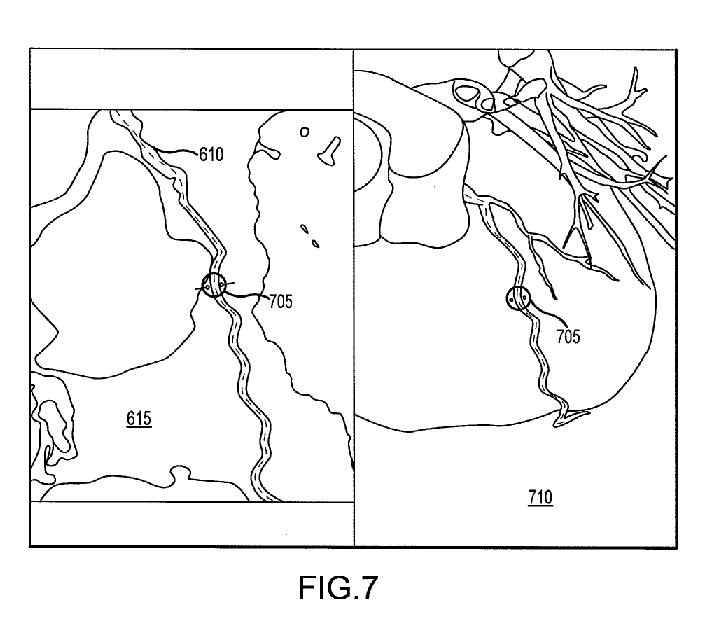

A schematic illustration of two aligned images of vessel 610 of heart 602 displayed on a computer display device, such as display device 230, is shown in FIG. 7. The image 615, generated in accordance with the curved planar reformation technique, remains displayed. A region 705 may be selected by a user or automated process, as generally described above. As described above, a direction of display of the region 705 may be calculated and used to select a viewpoint, rotation, or both for display of the image 710. The region 705 is also shown in the image 710. The image 710 has been generated, for example by one or more of the processing units 220 in accordance with executable instructions 240 using volume rendering techniques, where the viewpoint and rotation of the image 710 have been selected such that they align at the region 705 with the direction of display in the region 705 of the image 615. The selection of the viewpoint and rotation, as well as the rendering of the image 710, may be performed by one or more of the processing units 220 in accordance with executable instructions 240 of FIG. 2. Note that the vessel 610 is now generally oriented in a same manner between the images 615 and 710, which may facilitate an improved understanding of the vessel.

Accordingly, examples have been described above of methods, systems, and images for aligning a second image to an image generated in accordance with a curved planar reformation technique. A region on an image generated in accordance with a curved planar reformation technique may be indicated, and another image generated using a distinct technique, such as volume rendering, may be aligned with the image generated using the curved planar reformation technique. Other embodiments of the present invention may align an image generated using a curved planar reformation technique to an image generated using a distinct technique, such as volume rendering. That is, the imaging system 215 of FIG. 2 may also be configured to align an image generated in accordance with a curved planar reformation technique with another image generated using a distinct technique, as will be described further below.

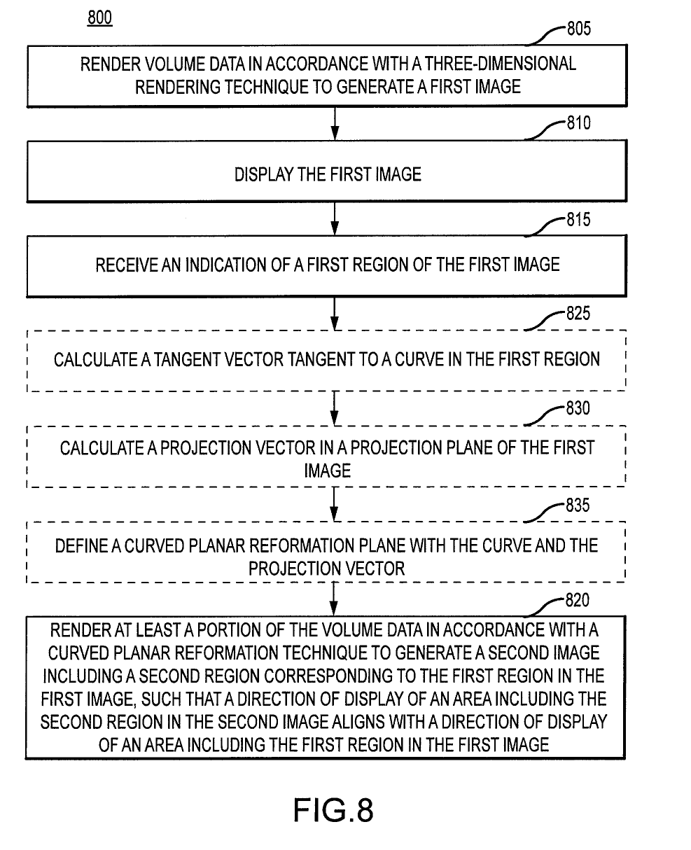

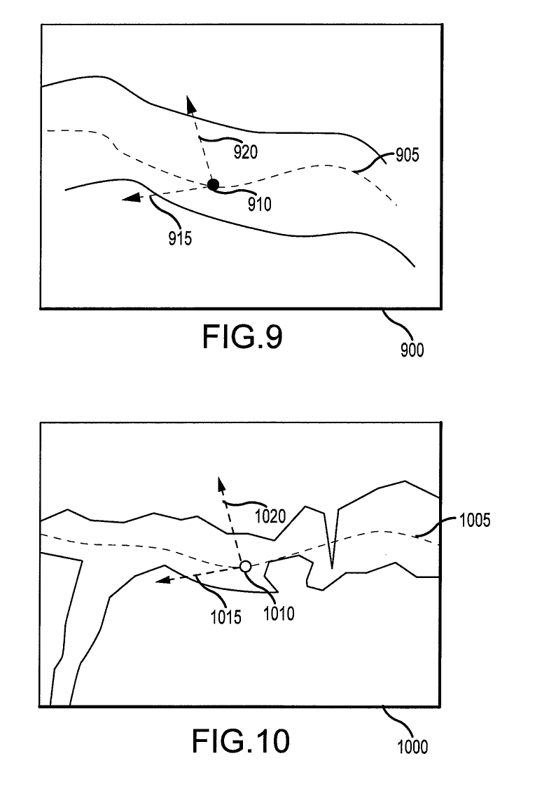

A schematic flowchart for a method 800 to render and align images utilizing a system of the invention, such as system 215, according to another embodiment of a method of the present invention is shown in FIG. 8. In block 805, volume data may be rendered in accordance with a three-dimensional rendering technique to generate a first image, such as the image 605 of FIG. 6. Images generated in accordance with the method of FIG. 8 will be described further below with reference to FIGS. 9 and 10. As generally described above, any of a variety of three-dimensional rendering techniques may be used including volume rendering. In block 810, the first image may be displayed, for example on a monitor or other output or display device 230 of the imaging system 215 of FIG. 2. In some embodiments, the imaging system 215 of FIG. 2 may be used to implement both the methods of FIGS. 3 and 8. In other embodiments, separate imaging systems may be used, or the imaging system 215 may only be configured to perform the method of FIG. 3 or FIG. 8.

In block 815, an indication of a first region of the first image may be received. As described above with reference to FIG. 7, a region 705 was indicated on the image 615 generated in accordance with the curved planar reformation technique. However, in an embodiment of FIG. 8, an indication of a first region on the image 605 of FIG. 6 may be received. The indication may be provided by a user viewing the image or by another computer software process which analyzed the image. The first region may be specified, for example, by a user highlighting the region on the image using a mouse or other input device 225 of the system 215 illustrated in FIG. 2. The first region may also be referred to as an attention region. The region may be a point, a pixel, or a region enclosing multiple points or pixels. The first region may generally be small relative to variations in the direction of display of regions of the image.

In block 820, a second image of the volume data may be displayed. The second image may be rendered using a curved planar reformation technique, such as the image 615 of FIG. 6. The second image contains a second region corresponding to the first region in the first image. That is, the second image includes the portion of the volume data corresponding to the first region of the first image. For example, the first image may be an image of a heart in a mammalian body that includes a vessel, such as vessel 610 of heart 602. The second image may be an image of the vessel. The first region may be a portion of the vessel, shown in both the first and second images. The second image may be a curved planar reformation image generated using a curve corresponding to the vessel. The curved planar reformation image may be generated such that a direction of display of the second region corresponds to a direction of display of the first region, such that the images are aligned. That is, referring back to FIG. 6, the image 615 may be rendered, rotated, or otherwise adjusted to align with a direction of display of an indicated region of the image 605.

The first and second images may be aligned in a variety of ways, and the manner in which alignment is achieved may vary based on the technique used to generate the first and second images. In one example, the first image may be generated in accordance with any of the volume rendering techniques described above. The volume rendering technique may render an image on a projection plane from a viewpoint. The volume rendering image may include a curve that is used to generate a second image in accordance with a curved planar reformation technique. In block 825, a vector may be calculated tangent to the curve in the first region. The vector may be calculated by one or more processing units, such as the processing units 220 of system 215 illustrated in FIG. 2 in accordance with the executable instructions 240.

In block 830, a projection vector may be calculated in the projection plane of the first image. The projection vector may be in the projection plane and perpendicular to the tangent vector calculated in the block 825. The projection vector may be calculated by one or more processing units, such as the processing units 220 of system 215 illustrated in FIG. 2 in accordance with the executable instructions 240. The tangent vector and projection vectors generated in blocks 825 and 830 may be used in rendering a curved planar reformation image. In block 835, the curve and the projection vector may be used to define a plane for curved planar reformation imaging. Moreover, the curved planar reformation image may be rotated such that the tangent vector to the curve in the first region of the first image is aligned with the tangent vector to the curve in the second region of the second image.

In some examples, the second image may be generated responsive to receipt of the indication of the first region. In some examples, the second image may be generated prior to receipt of the indication of the first region, and a curved planar reformation plane, rotation, or both, of the second image may be adjusted responsive to receipt of the indication of the first region in block 815. In some examples, the two images may be linked such that as the selected first region changes in the first image, the second image is continuously adjusted to maintain alignment with the first image.

The executable instructions 240 of FIG. 2 may include instructions for performing any or all of the actions described above with reference to FIG. 8.

A schematic illustration of the method 800 utilizing a system such as system 215 is illustrated in FIGS. 9-10. A first image 900 generated in accordance with a volume rendering technique of such method is shown in FIG. 9. The first image 900 may contain the curve 905, which could for example be along vessel 610 of heart 602. A first region 910 may be specified by a user, such as by clicking on the image. The tangent vector 915 may be calculated responsive to the indication of the first region. The tangent vector 915 has a direction tangent to the curve 905 at the first region 915. As described above, a projection vector 920 may then be calculated that lies within the projection plane of the image 900 and is perpendicular to the tangent vector 915.

A schematic illustration of a second image 1000 generated in accordance with a curved planar reformation technique of such method is shown in FIG. 10. A second region 1010 depicts corresponding volume data as the first region 910 of the first image 900 of FIG. 9. The second image 1000 may be generated using a curved planar reformation technique along a plane defined by the curve 905, shown as 1005 in FIG. 10 and the projection vector 920, shown as 1020 in FIG. 10. That is, the second image 1000 is a curved planar reformation image of a plane defined by the curve 1005 and the projection vector 1020. The second image 1000 may also be rotated such that the projection vector 1020 is aligned with projection vector 920 and tangent vector 1015 aligned with tangent vector 915 of FIG. 9. In this manner, the image 1000 may be aligned with the image 900, which may facilitate understanding of the features in the images.

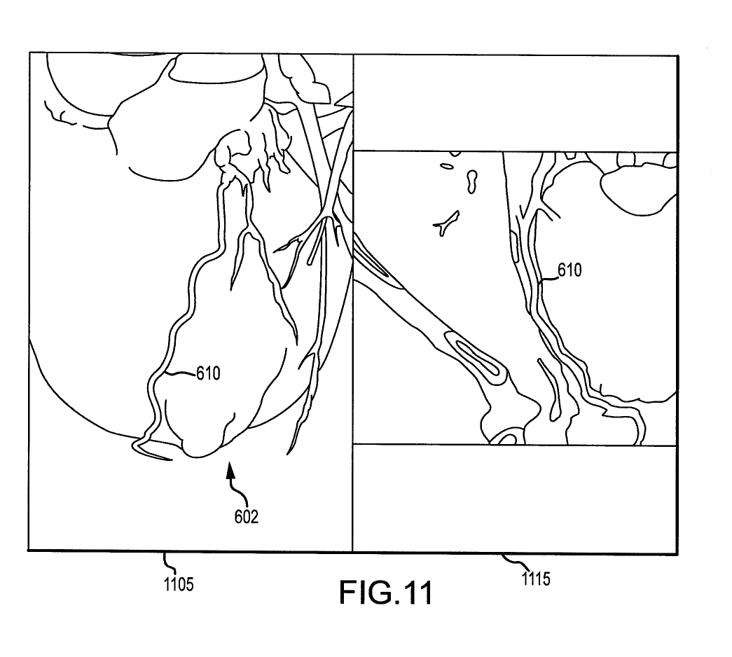

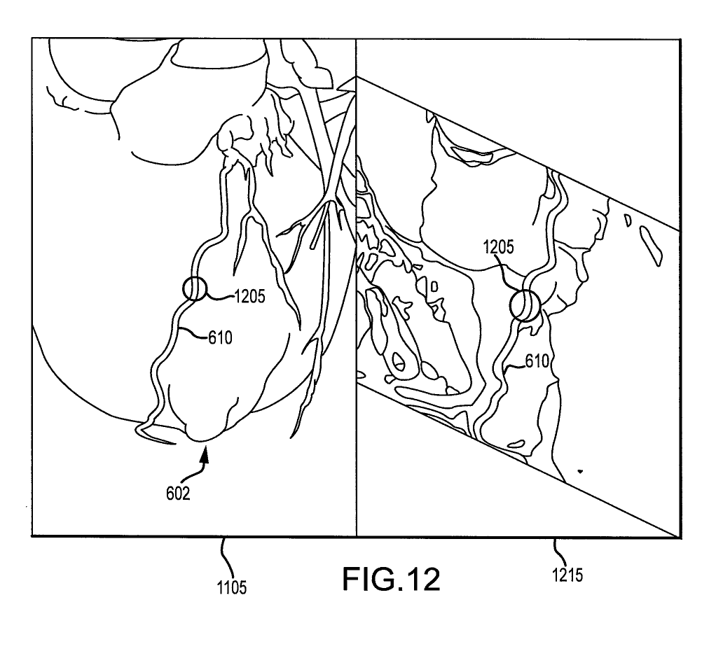

In a further illustration of an example of the invention, a schematic illustration of two non-aligned images displayed on a computer display device, such as display device or monitor 230 of FIG. 2, is shown in FIG. 11. The image 1105 was generated in accordance with a volume rendering technique, and may be generated by one or more of the processing units 220 of FIG. 2 using at least a portion of the volume data 245. The heart 602 is again shown and includes the vessel 610. A curve may be defined along the vessel 610 and used to generate another image, the image 1115, in accordance with curved planar reformation techniques. The image 1115 may also be displayed on an output device 230 of the imaging system 215 of FIG. 2, and may be displayed on a same or different device as the image 1105. The image 1115 also illustrates the vessel 610. However, note that the images 1105 and 1115 are not aligned. The orientation of the vessel 610 in image 1105 is different than the orientation of the vessel 610 in the image 1115.

A schematic illustration of two aligned images of vessel 610 of heart 602 displayed on a computer display device, such as display device 230, is shown in FIG. 12. The image 1105, generated in accordance with volume rendering techniques, remains displayed. A region 1205 may be selected by a user or automated process, as generally described above. As described above, the region 1205 may be used to determine a rotation or tangent vector for a curved planar reformation image also containing the region 1205. The image 1215 may be generated using curved planar reformation techniques and having a direction of the curve at the region 1205 corresponding to the direction of the curve at the region 1205 in the volume rendering image 1105. Note that the region 1205 in the curved planar reformation image may correspond to the same volume data as the region 1205 in the volume rendering image, however, the region may be somewhat distorted in shape due to restrictions or distortions that occur during rendering in accordance with the curved planar reformation technique. The image 1215 may be generated, for example, by one or more of the processing units 220 in accordance with executable instructions 240 using curved planar reformation techniques, where the projection vector used to generate the curved planar reformation image may be generated, based on a tangent vector to the curve in the region 1210 in the image 1105. The selection of the tangent vector, as well as the rendering of the image 1215, may be performed by one or more of the processing units 220 in accordance with executable instructions 240 of FIG. 2. Note that the vessel 610 is now generally oriented in a same manner between the images 1105 and 1215, which may facilitate an improved understanding of the vessel 610.

Accordingly, examples have been described above of methods, systems, and images for aligning a curved planar reformation image to an image generated in accordance with a distinct technique, such as volume rendering. A region on an image generated with a volume rendering technique may be indicated, and another image generated using a curved planar reformation technique may be aligned with the image generated using the volume rendering technique.

Certain details have been set forth above to provide a sufficient understanding of embodiments of the invention. However, it will be clear to one skilled in the art that embodiments of the invention may be practiced without various of these particular details. In some instances, well-known rendering techniques, software operations, computing components, circuits, and control signals have not been shown in detail in order to avoid unnecessarily obscuring the described embodiments of the invention.

From the foregoing it will be appreciated that, although specific embodiments of the invention have been described herein for purposes of illustration, various modifications may be made without deviating from the spirit and scope of the invention.

What is claimed is:

1. A method for displaying volume data, comprising rendering at least a portion of the volume data in accordance with a curved planar reformation technique to generate a first image, displaying the first image, receiving an indication of an attention location and surrounding first region having a direction of display in the first image, rendering at least a portion of the volume data in accordance with a technique distinct from the curved planar reformation technique to generate a second image that includes the attention location and surrounding second region having a direction of display aligned with the direction of display of the attention location and surrounding first region in the first image and displaying the second image.

2. The method of claim 1, wherein the first and second images of human anatomy.

3. The method of claim 1, further comprising calculating the direction of display of the first region in the first image.

4. The method of claim 3, wherein said curved planar reformation technique includes defining a surface at least in part by a curve and a projection vector and wherein the calculating step includes calculating a tangent vector tangent to the curve in the first region and making the direction of display perpendicular to both the tangent vector and the projection vector.

5. The method of claim 1, wherein the step of rendering at least a portion of the volume data in accordance with a technique distinct from the curved planar reformation technique includes rendering at least a portion of the volume data in accordance with a volume rendering technique.

6. The method of claim 4, wherein the step of rendering at least a portion of the volume data in accordance with a volume rendering technique includes rendering the volume data from a viewpoint along the direction of display.

7. The method of claim 1, wherein the step of displaying the second image includes re-orienting the second image at least in part responsive to receipt of the indication.

8. One or more computer readable storage media encoded with instructions executable by one or more processing units of a computing system, the instructions comprising instructions for rendering at least a portion of volume data in accordance with a curved planar reformation technique to generate a first image, displaying the first image, receiving an attention location and surrounding first region having a direction of display in the first image, rendering at least a portion of the volume data in accordance with a technique distinct from the curved planar reformation technique to generate a second image that includes the attention location and a surrounding second region having a direction of display aligned with the direction of display of the attention location and surrounding first region in the first image and displaying the second image.

9. The storage media of claim 8, wherein the first and second images comprise images of human anatomy.

10. The storage media of claim 8, wherein the instructions further comprise instructions for calculating the direction of display of the first region in the first image.

11. The storage media of claim 10, wherein said instructions for rendering in accordance with the curved planar reformation technique comprise instructions for defining a surface at least in part by a curve and a projection vector and wherein the instructions for calculating include instructions for calculating a tangent vector tangent to the curve in the first region and making the direction of display perpendicular to both the tangent vector and the projection vector.

12. The storage media of claim 8, wherein the instructions further comprise instructions for rendering the volume data in accordance with a technique distinct from the curved planar reformation technique comprise instructions for includes rendering at least a portion of the volume data in accordance with a volume rendering technique.

13. The storage media of claim 12, wherein the instructions for rendering in accordance with the volume rendering technique comprise instructions for rendering the volume data from a viewpoint along the direction of display.

14. The storage media of claim 8, wherein the instructions for displaying the second image comprise instructions for re-orienting the second image at least in part responsive to receipt of the indication.

15. An image processing system comprising at least one computer readable memory configured to store volume data, at least one processing unit coupled to the memory and configured to execute computer readable instructions for rendering at least a portion of volume data in accordance with a curved planar reformation technique to generate a first image, displaying the first image, receiving an attention location and surrounding first region having a direction of display in the first image, rendering at least a portion of the volume data in accordance with a technique distinct from the curved planar reformation technique to generate a second image that includes the attention location and a surrounding second region having a direction of display aligned with the direction of display of the attention location and surrounding first region in the first image and displaying the second image, and a display device coupled to the at least one processing unit and configured to display the first and second images.

16. The system of claim 15, wherein the first and second images comprise images of human anatomy.

17. The system of claim 15, wherein the at least one processing unit is further configured to execute instructions for calculating the direction of display of the first region in the first image.

18. The system of claim 16, wherein the at least one processing unit is further configured to execute instructions for defining a surface at least in part by a curve and a projection vector and wherein the instructions for calculating include instructions for calculating a tangent vector tangent to the curve in the first region and making the direction of display perpendicular to both the tangent vector and the projection vector.

19. The system of claim 15, wherein the at least one processing unit is further configured to execute instructions for rendering the volume data in accordance with a technique distinct from the curved planar reformation technique comprise instructions for includes rendering at least a portion of the volume data in accordance with a volume rendering technique.

20. The system of claim 19, wherein the at least one processing unit is further configured to execute instructions for rendering the volume data from a viewpoint along the direction of display.

21. The system of claim 15, wherein the at least one processing unit is further configured to execute instructions for re-orienting the second image at least in part responsive to receipt of the indication.

22. A method for displaying volume data, comprising rendering the volume data in accordance with a three-dimensional rendering technique to generate a first image, displaying the first image, receiving an indication of an attention location and surrounding first region having a direction of display in the first image, rendering at least a portion of the volume data in accordance with a curved planar reformation technique to generate a second image that includes the attention location and a surrounding second region having a direction of display aligned with the direction of display of the attention location and surrounding first region in the first image and displaying the second image.

23. The method of claim 22, wherein the first and second images comprise images of human anatomy.

24. The method of claim 22, wherein the three-dimensional rendering technique comprises a volume rendering technique.

25. The method of claim 22, wherein the first image lies in a projection plane and includes a curve, and wherein rendering at least a portion of the volume data in accordance with a curved planar reformation technique comprises calculating a tangent vector tangent to the curve at the attention location, calculating a projection vector in the projection plane perpendicular to the tangent vector, defining a curved planar reformation plane with the curve and the projection vector, and rendering at least a portion of the volume data on the curved planar reformation plane.

26. The method of claim 22, wherein the step of displaying the second image includes re-orienting the second image at least in part responsive to receipt of the indication.

27. One or more computer readable storage media encoded with instructions executable by one or more processing units of a computing system, the instructions comprising instructions for rendering the volume data in accordance with a three-dimensional rendering technique to generate a first image, displaying the first image, receiving an indication of an attention location and surrounding first region having a direction of display in the first image, rendering at least a portion of the volume data in accordance with a curved planar reformation technique to generate a second image that includes the attention location and a surrounding second region having a direction of display aligned with the direction of display of the attention location and surrounding first region in the first image and displaying the second image.

28. The storage media of claim 27, wherein the first and second images comprise images of human anatomy.

29. The storage media of claim 27, wherein the three-dimensional rendering technique comprises a volume rendering technique.

30. The storage media of claim 27, wherein the first image lies in a projection plane and includes a curve, and wherein the instructions for rendering at least a portion of the volume data in accordance with a curved planar reformation technique comprise instructions for calculating a tangent vector tangent to the curve at the attention location, calculating a projection vector in the projection plane perpendicular to the tangent vector, defining a curved planar reformation plane with the curve and the projection vector, and rendering at least a portion of the volume data on the curved planar reformation plane.

31. The storage media of claim 27, wherein the instructions for displaying the second image include instructions for re-orienting the second image at least in part responsive to receipt of the indication.

32. An image processing system comprising at least one memory configured to store volume data, at least one processing unit coupled to the memory and configured to execute computer readable instructions for rendering the volume data in accordance with a three-dimensional rendering technique to generate a first image, displaying the first image, receiving an indication of an attention location and surrounding first region having a direction of display in the first image, rendering at least a portion of the volume data in accordance with a curved planar reformation technique to generate a second image that includes the attention location and a surrounding second region having a direction of display aligned with the direction of display of the attention location and surrounding first region in the first image and displaying the second image, and a display device coupled to the at least one processing unit and configured to display the first and second images.

33. The system of claim 32, wherein the first and second images comprise images of human anatomy.

34. The system of claim 32, wherein the three-dimensional rendering technique comprises a volume rendering technique.

35. The system of claim 32, wherein the first image lies in a projection plane and includes a curve, and wherein the at least one processing unit is further configured to execute instructions for rendering at least a portion of the volume data in accordance with a curved planar reformation technique comprise instructions for calculating a tangent vector tangent to the curve at the attention location, calculating a projection vector in the projection plane perpendicular to the tangent vector, defining a curved planar reformation plane with the curve and the projection vector, and rendering at least a portion of the volume data on the curved planar reformation plane.

36. The system of claim 32, wherein the at least one processing unit is further configured to execute instructions for re-orienting the second image at least in part responsive to receipt of the indication.
